(19) United States
(12) Patent Application Publication
(10) Pub. No.: US 2026/0078308 A1
(43) Pub. Date: Mar. 19, 2026

(54) METHOD FOR REGENERATING A CATALYST FOR PROCESSING REACTIVE FEEDSTOCK

(71) Applicant: TOPSOE A/S, Kgs. Lyngby (DK)

(72) Inventors: Klas Jerker ANDERSSON, Kgs. Lyngby (DK); Ashwin Singh TENSINGH, Kgs. Lyngby (DK); Mathias BRINCH-LARSEN, Kgs. Lyngby (DK)

(73) Assignee: TOPSOE A/S, Kgs. Lyngby (DK)

(21) Appl. No.: 18/886,632

(22) Filed: Sep. 16, 2024

(51) Int. Cl. C10G 49/08; B01J 21/04; B01J 21/20; B01J 38/02; B01J 38/10

(52) U.S. Cl. CPC C10G 49/08; B01J 21/04; B01J 21/20; B01J 38/02; B01J 38/10; C10G 2300/4093

(57) ABSTRACT

A process for regeneration of a process enclosure and a catalyst comprising precipitated ammonium salts, and a process and a process plant for continuous hydrotreating a feedstock comprising nitrogen and halides.

### FIELD OF THE INVENTION

The invention relates to the field of hydroprocessing of liquid oils such as pyrolysis oils, more specifically to the stabilization of the liquid oil by hydrotreating prior to being upgraded by further hydroprocessing, such as hydrodeoxygenation (HDO) or hydrodenitrogenation (HDN).

### BACKGROUND OF THE INVENTION

The field of renewable feedstocks has been attracting a great deal of attention, in not only Europe, but also US and China. Using renewable feedstocks enables a sustainable approach to the production of hydrocarbon products boiling in the transportation fuel range, in particular any of diesel, jet fuel and naphtha as well as petrochemicals, such as raw materials for steam crackers and plastic production.

The hydroprocessing of renewable feedstocks is a challenging task, due to the variety and complexity of these feedstocks. Currently, it is normally perceived that there are three generations of renewable feedstocks. The first generation are renewable feedstocks which are already liquid and include virgin oils, such as rapeseed oil and soybean oil. The second generation are waste oil and fats, such as used cooking oils, animal fats and crude tall oil (CTO). The third generation is much larger in volume, i.e. is more available, than for instance the second generation. This third generation includes solid renewable feedstocks which encompasses: i) solid renewable feedstock, such as plastic waste, waste tyres, municipal solid waste, agricultural residue and forestry residue, for instance lignocellulosic biomass such as grass; and ii) low indirect land-use change (ILUC) crops such as castor, which offer the benefit of not competing for space with food crops and can be grown in difficult climates.

Due to the increased interest to abate fossil hydrocarbon feedstock to the petrochemical sector (plastic production), and to fuels production a higher demand is expected for the hydroprocessing of advanced renewable feedstocks, such as pyrolysis oils derived from solid renewable feedstocks.

Thermochemical decomposition oils from plastic are highly unsaturated containing olefins, diolefins, conjugated diolefins, aromatics, vinyl-aromatics as well as saturated hydrocarbons. These oils furthermore contain heteroatoms like nitrogen, oxygen, sulfur and halogens. Nitrogen may be present in biological material or selected polymers such as polyamides and polyurethanes. Organic halides may be present from biological sources or from plastic, such as chloride from PVC, bromide from flame retardants and fluoride from polyfluoroalkyls. The exact nature of plastic derived oils depends greatly on the polymer composition of the feedstock to the liquefaction process. In order to fulfil the requirements as petrochemical feedstock (e.g. for steam crackers) a large part of the olefinic hydrocarbons must be saturated and the heteroatoms must be decreased significantly.

Thermochemical decomposition oils from biomass may have a very high oxygen content, which needs to be decreased before it efficiently can be used as liquid fuel, i.e. as hydrocarbon fuel boiling in the transportation fuel range. The heteroatoms (like nitrogen, oxygen, sulfur and halogens) are generally removed by hydroprocessing in a catalytic hydrotreatment (HDT) reactor using high pressure (3000-20000 kPa) and high temperature (320-400° C.). However, a thermochemical decomposition product from a pyrolysis process, hydrothermal liquefaction process or solvolysis is very unstable and when heated it tends to polymerize, which leads to rapid catalyst deactivation and plugging of the catalyst bed of the HDT reactor, due to coking or gum formation. As a result, if mild stabilization is not practiced, the unstable, highly reactive molecules will polymerize and solidify leading to increased reactor down time.

For convenience, in the following the reactive feedstock to be treated in the present process is referred to as thermochemical decomposition oil, but a wide range of related thermochemical decomposition technologies exist, which produce similar oils with similar challenges, and hence the terminology thermochemical decomposition oil shall be used for convenience to cover all such oils produced by thermochemical decomposition of solids, unless otherwise stated, and the terminology mentioning e.g. pyrolysis oil and HTL oils as examples shall not be understood to exclude other thermochemical decomposition oils.

As a result, methods of stabilizing thermochemical decomposition oils such as pyrolysis oils or HTL oils at lower (<250° C.) temperatures have been developed. This stabilization at least partially converts organic nitrogen to ammonia and organic halides to hydrogen halides. However, in these cases, it has now been identified that salts, in particular ammonium salts, can form and be deposited in the reactor as the operation temperature is below the salt precipitation temperature. In reactors operated at standard high temperatures, ammonia and hydrogen halides may be formed in the reactor, but the reactor temperature is sufficiently high to keep these molecules in the gas phase, such that salts thereof are not deposited on the reactor bed. However, at the lower operating temperatures desired for stabilizing thermochemical decomposition oil such as pyrolysis oils or HTL oils, the salts can precipitate in the reactor itself, on external and internal surfaces of catalysts and in related equipment, such as heat exchangers.

Having salt precipitation in the stabilization reactor is a significant issue particularly since the salt precipitate may be deposited on the catalyst bed including within the pores of any hydrotreatment catalyst. This subsequently leads to blocking of the catalyst bed and rapid deactivation of the catalyst.

It would thus be desirable to provide a process for stabilizing a liquid oil stream at low temperatures that circumvents the problems associated with salt precipitation in the reactor.

### SUMMARY OF THE TECHNOLOGY

One aspect of the technology relates to a process for hydrotreating a liquid oil stream comprising at least 1 ppm wt halides, 20 ppm wt halides, 50 ppm wt halides or 100 ppm wt halides in combination with at least 1 ppm wt N, 10 ppm wt N, 50 ppm wt N, 100 ppm wt N or 500 ppm wt N; wherein the liquid oil stream is a thermochemical decomposition oil stream; the process comprising:
(i) a hydrotreatment step comprising hydrotreating the liquid oil stream in a fixed bed reactor at a temperature of less than 250° C., wherein the fixed bed reactor comprises a hydrotreatment catalyst; and
(ii) an in-situ catalyst regeneration step, wherein the in-situ catalyst regeneration step comprising flushing the hydrotreatment catalyst under regeneration conditions with a fluid, where said fluid and conditions are chosen, such that the solubility of ammonium salts in the fluid is sufficient for transferring deposited ammonium salts to the fluid.

This has the effect that one or more ammonium salts deposited on the hydrotreatment catalyst and process equipment are released from the hydrotreatment catalyst and transferred to the fluid. The term solubility shall in this regard be understood as the ability of the fluid to contain such salts, either in liquid solution or as gaseous mixture.

### DETAILED DESCRIPTION OF THE TECHNOLOGY

As discussed herein, in one aspect relates to a process for hydrotreating a liquid oil stream; wherein the liquid oil stream is a thermochemical decomposition oil stream; the process comprising:
(i) a hydrotreatment step comprising hydrotreating the liquid oil stream in a fixed bed reactor at a temperature of less than 250° C., wherein the fixed bed reactor comprises a hydrotreatment catalyst; and
(ii) an in-situ catalyst regeneration step such that one or more ammonium salts deposited on the hydrotreatment catalyst are removed from the hydrotreatment catalyst, wherein the in-situ catalyst regeneration step comprises heating the hydrotreatment catalyst with a flushing gas or a mixture of a flushing gas and oil, such as product oil.

Specifically, step (ii) may be an in-situ catalyst regeneration step, wherein the in-situ catalyst regeneration step comprising flushing the hydrotreatment catalyst under regeneration conditions with a fluid, where said fluid and conditions are chosen, such that the solubility of ammonium salts in the fluid is sufficient for transferring deposited ammonium salts to the fluid. While such a step is denoted a catalyst regeneration step, it shall be understood broadly as a regeneration step for the process equipment, and e.g. in the case of cold spots in the equipment, may be carried out even with no or little deactivation of catalyst. This regeneration shall be construed as being included in the term catalyst regeneration step, and the terminology catalytic material regeneration shall be applied for a step where only the catalytic material is regenerated.

By the related technology, the thermochemical decomposition oil stream, is stabilized at low temperatures by the conversion of at least the most reactive compounds in the thermochemical decomposition oil stream, such as furfural, furans, aldehydes, ketones and acids, into alcohols, for instance by efficiently converting carbonyl functional groups into alcohol functional groups. In addition, conjugated diolefins may be converted to mono-olefins, styrene may be converted to ethyl benzene and reactive mono-olefins and styrene homologues may be hydrogenated. The present invention provides a process for this mild stabilization whilst circumventing issues associated with the precipitation of ammonium-based salts within the reactor. As a result, clogging and subsequent deactivation of the hydrotreatment catalyst can be mitigated.

Ammonium based salts may precipitate especially during the hydrotreatment of oil comprising at least 1 ppm wt N, 10 ppm wt N, 50 ppm wt N, 100 ppm wt N or 500 ppm wt N; in combination with at least 1 ppm wt halides, 20 ppm wt halides, 50 ppm wt halides or 100 ppm wt halides, but also sulfur salts may precipitate, so a combination with presence of at least 20 ppm wt S, 50 ppm wt S or 100 ppm wt S may be especially relevant for this process, as ammonium bisulfite precipitate at higher temperatures than ammonium halides. In practice the content of N in the oil feed will be below 5-10 wt % and halides and S will be below 1 wt %. With less than 1 ppm wt N and 1 ppm wt of halides, precipitation may still occur, and the invention is therefore also valid and applicable for such feeds, but the amount of precipitation may be sufficiently low for operation for up to a year without a need for regeneration. These limits are given for halides, since at least F, Cl and Br are found in thermochemical decomposition oil from thermochemical decomposition of plastic, such as Cl from PVC, Br from flame retardants and F from PFAS compounds. The risk of precipitation will be lower if the release of inorganic halides from organic halide compounds by hydrotreatment is only partial, as the remainder of halides would be released only at elevated temperatures.

### Liquid Oil Stream

As used herein the feedstock is described as a reactive feedstock, which requires stabilization to avoid formation of viscous products by e.g. oligomerization. Such a feedstock may be defined by it's composition, but alternatively, the definition may also be functional, i.e. whether a feedstock is considered reactive may be evaluated by passive heating to 80° C., in a closed container, without stirring or provision of gas for 24 hr. If the viscosity as evaluated at 80° C. before and after the test, shows an increase by more than 20% the feedstock is considered reactive.

As used herein, the term “reactive feedstock” may refer to a thermochemical decomposition oil stream and relates to a feedstock comprising compounds which at above elevated temperatures (>80° C.) but below the temperatures resulting in substantially complete hydrotreatment may react to form larger molecules, potentially resulting in full or partial blockage of reactors, tubes, heaters, heat exchangers and catalysts. Non-limiting examples of such reactive mixtures may be feedstock rich in conjugated diolefins or styrene and its homologues from thermochemical decomposition of plastic waste, waste tyres, municipal solid waste, refuse derived fuel and solid recovered fuel, feedstock rich in carbonyls and sugars from thermochemical decomposition of lignocellulosic biomass and feedstock rich in nitrogen from thermochemical decomposition of nitrogen rich biomass, such as manure and sewage sludge, and similar composition from other sources. The reactive compounds may either react within the same functional group (for example, diolefin with diolefin) or across functional groups (for example, aldehyde with phenol). A stream comprising a “reactive feedstock” shall be understood to include also combinations of a non-reactive feedstock of biological or fossil origin with a reactive feedstock originating from thermochemical decomposition.

As discussed herein, the process of the invention relates to hydrotreatment of a liquid oil stream i.e., a thermochemical decomposition oil stream, such as a fossil oil stream, a renewable crude oil stream or a biocrude oil stream. In one aspect, the liquid oil stream contains at least 20 wt % oxygen (O), such as at least 30 wt % O, or at least 45 wt % O. In one aspect, the liquid oil stream contains from 1 to 50 wt % O, such as from 5 to 50 wt % O, such as from 10 to 50 wt % O, such as from 15 to 50 wt % O, such as from 20 to 50 wt % O, such as from 25 to 50 wt % O, such as from 30 to 50 wt % O, such as from 35 to 50 wt % O, such as from 40 to 50 wt % O, such as from 45 to 50 wt % O. The oxygen is suitably determined by standard elemental analysis. This oxygen content is representative of particularly reactive thermochemical decomposition oil feeds, such as pyrolysis oils, as the content of oxygen especially for oils of biological origin may serve as a proxy for how reactive the liquid oil is. Thus, a highly reactive liquid oil stream may contain as much as 45 wt % oxygen or even higher.

In one aspect, the liquid oil stream contains at least 500 ppm wt O, such as 0.1 wt. % O, such as at least 0.5 wt. % O, such as at least 1 wt. %, such as at least 1.5 wt. % O, such as at least 2 wt. % O, such as at least 2.5 wt. % O, such as at least 3 wt. % O, such as at least 3.5 wt. % O, such as at least 4.5 wt. % O, such as at least 5 wt. % O, such as at least 10 wt. % O, such as at least 15 wt. % O, which is representative of feedstock originating from the pyrolysis of material rich in plastic waste. In one aspect, the liquid oil stream contains from 0.1 to 15 wt. % O, such as from 0.5 to 15 wt. % O, such as from 1 to 15 wt. % O, such as from 2 to 15 wt. % O, such as from 3 to 15 wt. % O, such as from 4 to 15 wt. % O, such as from 5 to 15 wt. % O, such as from 6 to 15 wt. % O, such as from 7 to 15 wt. % O, such as from 8 to 15 wt. % O, such as from 9 to 15 wt. % O, such as from 10 to 15 wt. % O, such as from 11 to 15 wt. % O, such as from 12 to 15 wt. % O, such as from 13 to 15 wt. % O, such as from 14 to 15 wt. % O.

In one aspect, the thermochemical decomposition oil stream is a product of a pyrolysis process or a solvolysis process, such as hydrothermal liquefaction.

In one aspect the thermochemical decomposition oil stream comprises at least 0.5 mol/kg of one or more of: aldehyde compounds, ketones, alcohols, furfural, as determined by ASTM E3146-20 or alternatively at least 0.5 gl/100 g conjugated diolefins as determined according to ASTM UOP-326.

In one aspect, the process of the invention further comprises a prior step of thermal decomposition of a solid renewable feedstock, for producing said thermochemical decomposition oil stream.

As used herein, the term “thermal decomposition” shall be used broadly for any decomposition process, in which a material is partially decomposed at elevated temperature (typically 250° C. to 800° C. or even 1000° C.), in the presence of a substoichiometric amount of oxygen (including no oxygen). The product will typically be a combined liquid and gaseous stream, as well as an amount of solid char. The term shall be construed to include processes converting solids to liquids at elevated temperature, such as pyrolysis, solvolysis and hydrothermal liquefaction, both in the presence and absence of a catalyst. For convenience the product of thermal decomposition is called a thermochemical decomposition oil.

Accordingly, in a particular embodiment, the thermal decomposition is pyrolysis, such as fast pyrolysis, as defined below, thereby producing a pyrolysis oil stream.

It would be understood that thermal decomposition may be conducted in a thermal decomposition section, the pyrolysis may be conducted in a pyrolysis section, and hydrothermal liquefaction may be conducted in a hydrothermal liquefaction section.

As used herein, the term “section” means a physical section comprising a unit or combination of units for conducting one or more steps and/or sub-steps. For the purposes of the present invention, the pyrolysis section generates two main streams, namely a pyrolysis off-gas stream and a pyrolysis oil stream. The pyrolysis section may be in the form of a fluidized bed, transported bed, or circulating fluid bed, as is well known in the art. For instance, the pyrolysis section may comprise a pyrolyser unit (pyrolysis reactor), cyclone(s) to remove particulate solids such as char, and a cooling unit for thereby producing said pyrolysis off-gas stream and said pyrolysis oil stream, i.e. condensed pyrolysis oil. The pyrolysis off-gas stream comprises light hydrocarbons e.g. C1-C4 hydrocarbons, CO and CO₂. The pyrolysis oil stream is also referred to as a renewable crude oil stream or a biocrude oil stream and is a liquid substance rich in blends of molecules including saturated and unsaturated hydrocarbons, cyclic and aliphatic, as well as hydrocarbons that contain heteroatoms like nitrogen, oxygen, halogens and sulfur. Unsaturated hydrocarbons possibly include conjugated diolefins, styrene and styrene homologues. Hydrocarbons that contain heteroatoms include nitriles, amines, amides, thiols, sulfides, thiophenes, aldehydes, ketones and/or other compounds such as furfural having a carbonyl group, resulting from the depolymerization of the feedstock treated in pyrolysis

For the purposes of the present invention, the pyrolysis step is preferably fast pyrolysis or slow pyrolysis. Fast pyrolysis means the thermal decomposition of a solid renewable feedstock in the absence of oxygen, at temperatures in the range 350-650° C., e.g., about 500° C., and reaction times of 10 seconds or less, such as 5 seconds or less, such as 2 seconds or less. Fast pyrolysis may be conducted by autothermal operation e.g. in a fluidized bed reactor. The latter is also referred to as autothermal pyrolysis and is characterized by employing air, optionally with an inert gas or recycle gas, as the fluidizing gas, or by using a mixture of air and inert gas or recycle gas. Thereby, the partial oxidation of pyrolysis compounds being produced in the pyrolysis reactor (autothermal reactor) provides the energy for pyrolysis while at the same time improving heat transfer. For details about autothermal pyrolysis, reference is given to e.g “Heterodoxy in Fast Pyrolysis of Biomass” by Robert Brown:
https://dx.doi.org/10.1021/acs.energyfuels.0c03512.

“Intermediate” or “slow” pyrolysis are also suitable for feedstocks originating from waste plastics, and has lower cost and complexity than fast pyrolysis, and is currently the most widespread form of pyrolysis used for plastic waste and gives good oil yields. Biological feedstocks comprising alkaline metals have an increased risk of agglomeration and defluidization for slow pyrolysis.

In another embodiment, therefore, the pyrolysis step is intermediate pyrolysis, in which the vapor residence time is in the range of 10 seconds-5 minutes, such as 11 seconds-3 minutes. As for fast pyrolysis, the temperature is also in the range 350-650° C. e.g. about 500° C. Often this pyrolysis is conducted in pyrolysis reactors handling different types of waste, where the vapor is burned after the pyrolysis reactor. Typical reactors are: Herreshoff furnace, rotary drums, amaron, CHOREN paddle pyrolysis kiln, auger reactor, and vacuum pyrolysis reactor.

In another embodiment, the pyrolysis step is slow pyrolysis, in which the solid residence time is in the range of 5 minutes-2 hours, such as 10 min-1 hour. The temperature is suitably about 300° C. This pyrolysis gives a high char yield and the char can be used as a fertilizer or as char coal; the pyrolysis still produces some gas and renewable crude and if the carbon is used a fertilizer the final bio-oil can have a GHG saving above 100%, thus being carbon negative. Typical reactors are auger reactor (yet with a different residence time than for intermediate pyrolysis), fixed bed reactor, kiln, lambiotte SIFIC/CISR retort, Lurgi process, wagon reactor, and carbo twin resort. It would therefore be understood, that for the purpose of the present invention, the use of autothermal pyrolysis. i.e. autothermal operation, is a particular embodiment for conducting fast pyrolysis.

There are several types of fast pyrolysis where a catalyst is used. Sometimes an acid catalyst, such as zeolite or silica-alumina catalysts, is used in the pyrolysis reactor to upgrade the pyrolysis vapors, this technology is called catalytic fast pyrolysis and can both be operated in an in-situ mode (the catalyst is located in the pyrolysis reactor) and an ex-situ mode (the catalyst is placed in a separate reactor). The use of a catalyst conveys the advantage of lowering the activation energy for reactions thereby significantly reducing the required temperature for conducting the pyrolysis. In addition, increased selectivity towards desired pyrolysis oil compounds may be achieved. In some cases, hydrogen is added to the catalytic pyrolysis, which is called reactive catalytic fast pyrolysis. If the catalytic pyrolysis is conducted at a high hydrogen pressure (˜>0.5 MPag) it is often called catalytic hydropyrolysis. In one aspect, the pyrolysis stage is fast pyrolysis, which is conducted without the presence of a catalyst and hydrogen, i.e. the fast pyrolysis stage is not catalytic fast pyrolysis, hydropyrolysis or catalytic hydropyrolysis. This enables a much simpler and inexpensive process.

In one aspect, said pyrolysis off-gas stream comprises CO, CO₂ and light hydrocarbons such as C1-C4, and optionally also H₂S, HCl, HBr, HF, HCN and NH₃.

In one aspect, the thermal decomposition is hydrothermal liquefaction. Hydrothermal liquefaction means the thermochemical conversion of biomass into liquid fuels by processing in a hot, pressurized water environment for sufficient time to break down the solid polymeric structure to mainly liquid components. Typical hydrothermal processing conditions are temperatures in the range from 200° C. or 250° C. to 375° C. or 425° C. and operating pressures in the range of 4 MPag to 22 MPag or 25 MPag. This technology offers the advantage of operation at a lower temperature, higher energy efficiency and lower tar yield compared to pyrolysis, e.g. fast pyrolysis. For details on hydrothermal liquefaction of biomass, reference is given to e.g. Golakota et al., “A review of hydrothermal liquefaction of biomass”, Renewable and Sustainable Energy Reviews, vol. 81, Part 1, January 2018, p. 1378-1392. Solvolysis is a generalized form of hydrothermal liquefaction, in which the process is carried out in presence of other liquids, such as alcohols or liquid product.

In one aspect, the thermal decomposition further comprises passing said solid renewable feedstock through a solid renewable feedstock preparation section comprising for instance drying for removing water and/or comminution for reduction of particle size. Any water/moisture in the solid renewable feedstock, which vaporizes in for instance the pyrolysis section, condenses in the pyrolysis oil stream and is thereby carried out in the process, which may be undesirable. Furthermore, the heat used for the vaporization of water withdraws heat which otherwise is necessary for the pyrolysis. By removing water and providing a smaller particle size in the solid renewable feedstock, the thermal efficiency of the pyrolysis section is increased.

In an embodiment, the solid renewable feedstock is a lignocellulosic biomass including: wood products, forestry waste, and agricultural residue. In another embodiment, the solid renewable feedstock is municipal waste, in particular the organic portion thereof. For the purposes of the present application, the term “municipal waste” is interchangeable with the term “municipal solid waste” and means a feedstock containing materials of items discarded by the public, such as mixed municipal waste given the waste code 200301 in the European Waste Catalogue. Solid feedstock shall also be understood to include dispersed solid materials, such as sewage sludge and manure, in which at least 5 weight % is solid.

In one aspect, the lignocellulosic biomass is forestry waste and/or agricultural residue and comprises biomass originating from plants including grass such as nature grass (grass originating from natural landscape), wheat e.g. wheat straw, oats, rye, reed grass, bamboo, sugar cane or sugar cane derivatives such as bagasse, maize and other cereals.

In one aspect, the solid renewable feedstock is waste plastic or municipal waste rich in waste plastic.

Any combinations of the above are also envisaged.

As used herein, the term “lignocellulosic biomass” means a biomass containing, cellulose, hemicellulose and optionally lignin. The lignin or a significant portion thereof may have been removed, for instance by a prior bleaching step.

The terms a “feedstock of plastic or polymeric origin” or “waste plastic or polymer” may be understood as including a mixed or sorted waste comprising at least 50 wt %, 80 wt % or 90 wt % plastic and other synthetic polymers-which may be of biological or fossil origin.

The units “kPag” and MPag, shall in compliance with the practice of the field be used to denote kPa and MPa, gauge, i.e. the pressure relative to the surrounding pressure.

### Hydrotreatment Step

As discussed herein, the process of the invention comprises an initial hydrotreatment step comprising hydrotreating the liquid oil stream in a fixed bed reactor at a temperature of less than 250° C., wherein the fixed bed reactor comprises a hydrotreatment catalyst. The hydrotreatment process will typically be exothermic, such that the temperature in the outlet of the reactor will be higher than in the inlet, unless temperature control by addition of cold gas or liquid is practiced. As the catalyst activity decreases over time, common practice is to operate reactors with a low “start of run” temperature and increase that towards “end of run”, after which a catalyst replacement or reactivation is required.

In one aspect the liquid oil stream is hydrotreated in the fixed bed reactor at a stabilization temperature of less than 250° C., such as less than 240° C., such as less than 230° C., such as less than 220° C., such as less than 210° C., such as less than 200° C., such as less than 190° C., such as less than 180° C., such as less than 170° C., such as less than 160° C., such as less than 150° C., such as less than 140° C., such as less than 130° C., such as less than 120° C., such as above 110° C., such as above 100° C., such as above 90° C., such as above 80° C., such as above 70° C. In one aspect the liquid oil stream is hydrotreated in the fixed bed reactor at a stabilization temperature of from 70 to 250° C., such as from 70 to 240° C., such as from 70 to 230° C., such as from 70 to 220° C., such as from 70 to 210° C., such as from 70 to 200° C., such as from 70 to 190° C., such as from 70 to 180° C., such as from 70 to 170° C., such as from 70 to 160° C., such as from 70 to 150° C., such as from 70 to 140° C., such as from 70 to 130° C., such as from 70 to 120° C., such as from 70 to 110° C., such as from 70 to 100° C., such as from 70 to 90° C., such as from 70 to 80° C. In one aspect, the liquid oil stream is hydrotreated in a fixed bed reactor at a stabilization temperature in the range 80-250° C., such as in the range 150-250° C., such as in the range 150-200° C.

In one aspect, the stabilization temperature is in the range 100-225° C., e.g. 150-200° C.; the pressure is from 0.5 MPag, 1 MPag, 4 MPag, 10 MPag or 12.5 MPag to 16 MPag, 17.5 MPag or 25 MPag e.g. 15 MPag; and LHSV is 0.8-1.0 h⁻¹ e.g. 0.9 h⁻¹. At these particular conditions, compounds such as cyclopentanone or furfural present in e.g. pyrolysis oil are substantially converted to the respective alcohols. For instance, at 150-200° C., about 15 MPag, and LHSV of about 0.9 h⁻¹, optionally where the hydrogen to liquid oil ratio is 1000-1300 NL/L e.g. 1100-1200 NL/L, the conversion of furfural, an organic compound normally derived from the renewable source lignocellulosic biomass, is up to 100%, but where conversion of olefins is concerned much lower hydrogen to liquid oil ratios such as 1-100 NL/L may be preferred.

In one aspect, the stabilization temperature is in the range 80-250° C., the pressure is from 0.5-25 MPag, LHSV is from 0.1 hr⁻¹ to 10 h⁻¹, the H2-to-oil ratio is from 1 NL/L to 1000 NL/L. These hydrotreatment conditions are ideal for the hydrogenation of conjugated diolefins, styrene and styrene homologues.

In one aspect, the hydrotreatment catalyst converts at least one of conjugated diolefins to the corresponding mono-olefin or paraffin, styrene to ethylbenzene, furfural, furans, aldehydes, ketones and acids, into alcohols, and/or carbonyls into alcohols. The alcohols can further be converted to saturated organic compounds during the stabilization, and/or in a subsequent hydroprocessing stage such as HDO.

In one aspect, the hydrotreatment catalyst comprises one or more metals selected from the group comprising Mo, Ni, Co, W, Pt, Pd, Cu, Fe, Zn and Ru based catalysts and combinations thereof commonly supported on a refractive oxide, such as Al₂O₃, SiO2, TiO₂, amorphous silica-alumina or activated carbon. In one aspect, the catalyst is in sulfided or reduced form.

In one aspect, the catalyst is Ni-based, Mo-based, CoMo-based, NiMo-based, W-based, NiW-based or Ru-based. In one aspect, the catalyst is in sulfided, partially sulfided (i.e., surface-passivated with sulfur) or reduced form. In some aspects, the catalyst may comprise the elements B, P or C.

In one aspect, the Ni-based catalyst comprises Ni in an amount of at least 90 wt % based on the Group 1-12 materials in the catalyst, such as at least 95 wt. % such as at least 99 wt. % such as 100 wt. %. In one aspect, the Mo-based catalyst comprises Mo in an amount of at least 90 wt % based on the Group 1-12 materials in the catalyst, such as at least 95 wt. % such as at least 99 wt. % such as 100 wt. %. In one aspect, the W-based catalyst comprises W in an amount of at least 90 wt % based on the Group 1-12 materials in the catalyst, such as at least 95 wt. % such as at least 99 wt. % such as 100 wt. %. In one aspect, the Ru-based catalyst comprises Ru in an amount of at least 90 wt % based on the Group 1-12 materials in the catalyst, such as at least 95 wt. % such as at least 99 wt. % such as 100 wt. %.

In one aspect, the Ni-based catalyst comprises from 2-30 wt % Ni sulfided or reduced. In one aspect, the Mo-based catalyst comprises from 2-30 wt % Mo preferably sulfided. In one aspect, the CoMo-based catalyst comprises from 1-10 wt % Co and from 2-30 wt % Mo preferably sulfided. In one aspect, the NiMo-based catalyst comprises from 1-10 wt % Ni and from 2-30 wt % Mo preferably sulfided. In one aspect, the W-based catalyst comprises from 2-30 wt % W preferably sulfided. In one aspect, the NiW-based catalyst comprises from 1-10 wt % Ni and from 2-30 wt % W preferably sulfided. In one aspect, the Ru-based catalyst comprises from 0.1-10 wt % Ru preferably reduced.

In one aspect, the hydrotreatment catalyst comprises Mo. In one aspect, the hydrotreatment catalyst comprises Co. In one aspect, the hydrotreatment catalyst comprises Ni. In one aspect, the hydrotreatment catalyst comprises W. In one aspect, the hydrotreatment catalyst comprises Pt. In one aspect, the hydrotreatment catalyst comprises Pd. In one aspect, the hydrotreatment catalyst comprises Cu. In one aspect, the hydrotreatment catalyst comprises Fe. In one aspect, the hydrotreatment catalyst comprises Zn. In one aspect, the hydrotreatment catalyst comprises Ru. In one aspect, the hydrotreatment catalyst is a NiMo based catalyst.

In one aspect the hydrotreatment catalyst is a supported catalyst. In one aspect, the support is selected from alumina, silica, titania, magnesia and combinations thereof, i.e. a refractory support. The combinations may be as physical mixtures or as oxide systems, such as silica-alumina, alumina-magnesia spinel and other spinel-group oxide systems. In another particular embodiment, the support is a molecular sieve having topology MFI, BEA or FAU. As used herein, the term “topology MFI, BEA or FAU”, means a structure as assigned and maintained by the International Zeolite Association Structure Commission in the Atlas of Zeolite Framework Types, which is at http://www.iza-structure.org/databases/or for instance also as defined in “Atlas of Zeolite Framework Types”, by Ch. Baerlocher, L. B. McCusker and D. H. Olson, Sixth Revised Edition 2007.

In one aspect, the catalyst is sulfided. In one aspect, the hydrotreatment catalyst is a Ni—Mo based catalyst in sulfided form, i.e. NiMoS. In one aspect, the hydrotreatment catalyst is a Co—Mo based catalyst in sulfided form, i.e. CoMoS. The catalyst may be pre-sulfided by exposure to a sulfur containing stream or it may be sulfided in-situ i.e. during operation, for instance by sulfur present in the pyrolysis oil. In one aspect, the catalyst is reduced from oxide form to metallic form. In one aspect, the catalyst is pre-reduced or reduced by exposure to a hydrogen containing stream in-situ.

By the present invention, it has been found that an alcohol in the pyrolysis oil is first dehydrated to the respective unsaturated organic compound e.g. alkene and then hydrogenated to the respective saturated organic compound, e.g. alkane. For instance, 1-octanol present in the pyrolysis oil is first dehydrated to octene and then hydrogenated to octane. On the other hand, a ketone such as cyclopentanone (a cyclic ketone) is first hydrogenated to the respective alcohol, namely cyclopentanol and then dehydrated to cyclopentene, prior to being hydrogenated to cyclopentane. The dehydration is inhibited by pyridine (C₅H₅N, i.e. a compound having an organic nitrogen) present in the pyrolysis oil, thus indicating that pyridine is adsorbed on the acid sites. However, the hydrogenation is not inhibited by pyridine, thus showing that the catalyst according to the conditions of the present invention is able to convert aldehydes and ketones or other compounds having carbonyl groups in the pyrolysis oil, which normally contains organic sulfur and nitrogen, to alcohols. In other words, the desired reaction in which compounds having carbonyl groups such as aldehydes and ketones, are converted by hydrogenation to their corresponding alcohols is enabled. The alcohols may be dehydrated to the corresponding alkanes, either as part of the reactions taking place in the stabilization, or in a subsequent hydrodeoxygenation. In addition, saturation of conjugated diolefins and styrene homologues in the liquid oil as well as a reduction in the amount of heteroatoms is enabled.

In addition to the hydrotreatment stabilization step described above, the process will commonly include a further final hydrotreatment step at a higher temperature, at which precipitation of ammonium salts will not occur.

### In-Situ Catalyst Regeneration Step

As discussed herein, methods of stabilizing liquid oils such as pyrolysis oils or HTL oils at low temperatures have been developed. However, in these cases, it has been identified that salts can form and deposit in the reactor as the operation temperature is below the salt precipitation temperature. Having salt precipitation in the stabilization reactor is a significant issue particularly since the salt precipitate may be deposited on the catalyst bed including within the pores of the catalyst as well as on the surface of vessels and equipment. This subsequently leads to blocking of the catalyst bed and rapid deactivation of the hydrotreatment catalyst and other operational issues.

As a result, as discussed herein the process of the invention comprises an in-situ catalyst regeneration step such that one or more ammonium salts deposited on the hydrotreatment catalyst are removed from the hydrotreatment catalyst.

In one aspect, the one or more ammonium salts are selected from ammonium halides, ammonium sulfur salts and mixtures thereof. In one aspect, the one or more ammonium salts are ammonium halides and mixtures thereof. In one aspect, the one or more ammonium salts are ammonium hydrosulfides, ammonium sulfite and ammonium bisulfite and mixtures thereof. In one aspect, the one or more ammonium salts are at least ammonium chloride which may precipitate in the stabilization reactor, and thus may cause deactivation and pressure drop. When the terminology sublimation or decomposition temperature of salts is used, this shall be in consideration of relevant conditions, e.g. partial pressures of relevant gaseous compounds, and for practical purposes, this temperature will also define the precipitation temperature.

In one aspect, the in-situ catalyst regeneration step comprises heating the hydrotreatment catalyst with a fluid such as a flushing gas, or mixtures of a flushing gas and oil, such as a product oil. In one aspect, the in-situ catalyst regeneration step comprises heating the hydrotreatment catalyst with a flushing gas. In one aspect, the in-situ catalyst regeneration step comprises heating the hydrotreatment catalyst with a mixture of a flushing gas and oil, such as product oil, but preferably the nature of the oil is such that the extent of reaction and thus the hydrogen consumption and release of ammonium and halides is minimal under regeneration conditions, such as less than 10%, 1% or even less than 1/1000 of at least one of the hydrogen consumption and ammonia and halide release during operation. The heating is commonly carried out by contact with a heated gas, which is heated by heat exchange with product of exothermal reactions, and in which the temperature is controlled by flow rate in heat exchangers and combination with other flows.

Heating the hydrotreatment catalyst leads to sublimation of any ammonium salts deposited thereon, such that the solid salts are decomposed into NH₃ and hydrogen halides in the gas phase and can be removed from the reactor and the hydrotreatment catalyst regenerated. For simplicity the word sublimation shall be used to cover all aspects of a solid compound transferring to the gas phase in amounts of industrial relevance, including sublimation of the compound and the mentioned decomposition of a compound. In the text the term regeneration and stripping may also be used, which implies that a sublimation process occurs in relation to a catalyst or process equipment.

In one aspect, the flushing gas remains in the gas phase during all operating conditions and does not react with any catalyst or corrode construction materials. In one aspect, the flushing gas is selected from a hydrogen rich gas which is used in the related process, a nitrogen rich gas, or a methane rich gas which is commonly available in the relevant process plants, and a helium rich gas or an argon rich gas which are compatible with the process and combinations thereof. To protect the catalyst activity a presence of sulfide may be beneficial.

In one aspect, the flushing gas is a hydrogen rich gas. In one aspect, the hydrogen rich gas contains hydrogen in an amount of 60 vol. %. In one aspect, the hydrogen rich gas contains hydrogen in an amount of 65 vol. %. In one aspect, the hydrogen rich gas contains hydrogen in an amount of 70 vol. %. In one aspect, the hydrogen rich gas contains hydrogen in an amount of 75 vol. %. In one aspect, the hydrogen rich gas contains hydrogen in an amount of 80 vol. %. In one aspect, the hydrogen rich gas contains hydrogen in an amount of 85 vol. %. In one aspect, the hydrogen rich gas contains hydrogen in an amount of 95 vol. %. In one aspect, the hydrogen rich gas contains hydrogen in an amount of 99 vol. %.

In one aspect, the flushing gas is a nitrogen rich gas. In one aspect, the nitrogen rich gas contains nitrogen in an amount of 60 vol. %. In one aspect, the nitrogen rich gas contains nitrogen in an amount of 65 vol. %. In one aspect, the nitrogen rich gas contains nitrogen in an amount of 70 vol. %. In one aspect, the nitrogen rich gas contains nitrogen in an amount of 75 vol. %. In one aspect, the nitrogen rich gas contains nitrogen in an amount of 80 vol. %. In one aspect, the nitrogen rich gas contains nitrogen in an amount of 85 vol. %. In one aspect, the nitrogen rich gas contains nitrogen in an amount of 95 vol. %. In one aspect, the nitrogen rich gas contains nitrogen in an amount of 99 vol. %.

In one aspect, the flushing gas contains sulfur. In one aspect, the flushing gas is a hydrogen rich gas containing hydrogen sulfide. In one aspect, the hydrogen rich gas contains NH₃. In one aspect the hydrogen rich gas contains hydrogen halides.

In one aspect, during the regeneration step the hydrotreatment catalyst is heated at a temperature of from 100 to 320° C. In one aspect, the hydrotreatment catalyst is heated at a temperature of from 150 to 320° C. In one aspect, the hydrotreatment catalyst is heated at a temperature of from 200 to 320° C. In one aspect, the hydrotreatment catalyst is heated at a temperature of from 250 to 320° C. In one aspect, the hydrotreatment catalyst is heated at a temperature of from 250 to 300° C. In one aspect, the hydrotreatment catalyst is heated at a temperature of from 280 to 300° C.

In one aspect, during the regeneration step the hydrotreatment catalyst is heated at a temperature of from 160° C. to 320° C. In one aspect, the hydrotreatment catalyst is heated at a temperature of from 160 to 300° C. In one aspect, the hydrotreatment catalyst is heated at a temperature of from 160 to 250° C. In one aspect, the hydrotreatment catalyst is heated at a temperature of from 160 to 200° C. In one aspect, the hydrotreatment catalyst is heated at a temperature of from 170 to 190° C.

In one aspect, during the regeneration step the hydrotreatment catalyst is heated at a temperature of from 150 to 320° C. In one aspect, the hydrotreatment catalyst is heated at a temperature of from 200 to 320° C. In one aspect, the hydrotreatment catalyst is heated at a temperature of from 150 to 300° C. In one aspect, the hydrotreatment catalyst is heated at a temperature of from 250 to 300° C. In one aspect, the hydrotreatment catalyst is heated at a temperature of from 200 to 250° C.

An aspect of the regeneration which may have to be considered is the fact that solid salts may expand in a narrow temperature window when undergoing a solid-solid structural phase transition. Such expansion may cause structural damage to catalysts if the salt is precipitated inside the pores of the catalyst. Therefore, a specific narrow temperature range may initially be preferred around the salt solid-solid structural phase transition, such as one of the solid-solid structural phase transitions of ammonium chloride, which occurs around 180-200° C. for the pure salt. When precipitated salts are not pure, the solid-solid structural phase transition onset temperature may be different, and appropriate considerations must be made.

In general, regeneration at moderate temperatures such as below 190° C. or 210° C. may limit the expansion of ammonium salts due to phase-transition, at least for a period until significant amounts of ammonium salts have been removed. On the other hand, the sublimation rates increase significantly with temperature, which may cause a benefit of regeneration at elevated temperatures, such as up to 290° C., 300° C. or even 320° C.

Another aspect of the regeneration is the fact that carbon and oligomers of the feedstock may have precipitated. It is preferably not desired to react such deposits, as the consequence may be a partial reaction and release of deposits which may be deposited downstream in a final hydrotreatment reactor. Therefore, it is desired to keep the regeneration temperature in an interval above the temperature where sublimation of ammonium salts occurs, and below the temperatures where hydrogen is consumed, under formation of e.g. methane from deposited coke and hydrocarbons. The lower and upper limit of the regeneration temperature may be determined by directing heated gas to the reactor and monitoring the difference between the inlet and outlet gas composition for products of sublimation (e.g. ammonia and hydrogen halides in the gas) and hydrogenation (the amount of hydrocarbons in the gas or indirectly by monitoring hydrogen consumption). The practical rate of regeneration may preferably be controlled by limiting the flow rate (the space velocity) and thus mass transfer during regeneration or by limiting the sublimation rate by lowering the temperature, to avoid excessive release of e.g. ammonia and hydrochloride, causing operational issues such as corrosion risk. Reducing the total pressure will have the effect of increasing sublimation rates and this may also be used in the control of sublimation rates.

It may further in some aspects be desired to have a regeneration temperature somewhat above the lowest possible sublimation temperature. This will give the benefit of providing a potential of a high sublimation rate—and thereby allow control of the effective regeneration rate by using the gas flow rate as a limiting factor. The gas flow rate may be measured as the volume of gas per hour, but commonly gas flow rates are standardized to the “normal” conditions (0° C. and 1 atmosphere), and for convenient appreciation of the variation of reactor volumes, the flow rate may be considered as the gas hourly space velocity (GHSV) at normal conditions by dividing the gas flow rate in Nm³ with the catalyst volume.

In one aspect, the catalyst regeneration step is performed at a pressure substantially corresponding to atmospheric pressure such as deviating by less than 15 kPag e.g. from −15 kPag to 15 kPag. In one aspect, the catalyst regeneration step is performed at a pressure deviating by less than 13 kPag. In one aspect, the catalyst regeneration step is performed at a pressure deviating by less than 11 kPag. In one aspect, the catalyst regeneration step is performed at a pressure deviating by less than 9 kPag. In one aspect, the catalyst regeneration step is performed at a pressure deviating by less than 7 kPag. In one aspect, the catalyst regeneration step is performed at a pressure deviating by less than 5 kPag. In one aspect, the catalyst regeneration step is performed at a pressure deviating by less than 3 kPag.

In one aspect, the catalyst regeneration step is performed at a pressure substantially corresponding to active process conditions such as of 500 to 15000 kPag. In one aspect, the catalyst regeneration step is performed at a pressure of 3000 to 25000 kPag. In one aspect, the catalyst regeneration step is performed at a pressure of 5000 to 15000 kPag. In one aspect, the catalyst regeneration step is performed at a pressure of 7000 to 15000 kPag. In one aspect, the catalyst regeneration step is performed at a pressure of 9000 to 15000 kPag. In one aspect, the catalyst regeneration step is performed at a pressure of 11000 to 15000 kPag. In one aspect, the catalyst regeneration step is performed at a pressure of 13000 to 15000 kPag.

In one aspect, the catalyst regeneration step is performed at a pressure of 3000 to 13000 kPag. In one aspect, the catalyst regeneration step is performed at a pressure of 3000 to 11000 kPag. In one aspect, the catalyst regeneration step is performed at a pressure of 3000 to 9000 kPag. In one aspect, the catalyst regeneration step is performed at a pressure of 3000 to 7000 kPag.

In one aspect, the hydrotreatment catalyst is heated as above for a period of at least 500 hours. In one aspect, the hydrotreatment catalyst is heated as above for a period of at least 1000 hours. In one aspect, the hydrotreatment catalyst is heated as above for a period of at least 2000 hours. In one aspect, the hydrotreatment catalyst is heated as above for a period of at least 3000 hours. In one aspect, the hydrotreatment catalyst is heated as above for a period of at least 4000 hours. In one aspect, the hydrotreatment catalyst is heated as above for a period of at least 5000 hours. In one aspect, the hydrotreatment catalyst is heated as above for a period of at least 10000 hours.

In one aspect, the hydrotreatment catalyst is heated for regeneration as above for a period of from 500 to 10000 hours. In one aspect, the hydrotreatment catalyst is heated as above for a period of from 500 to 10000 hours, such as from 1000 to 10000 hours, such as from 2000 to 10000 hours, such as from 3000 to 10000 hours. Preferably the regeneration conditions (flushing gas flow rate and temperature) are chosen such that the regeneration mode duration is from 25% to 100% duration of the operational mode, such as from 30% to 80% of the duration, such that the release from regeneration is maintained in the same order of magnitude as during operation, which results in similar requirements to materials in terms of e.g. corrosion resistance, while ensuring availability of the regenerated reactor at the end of viable operation. In practice this may require a mode of regeneration involving more than two reactors, such as three, with two reactors concurrently in regeneration mode. It may also be the case that a reactor is fully regenerated (which may be detected by monitoring of the outlet from the regenerated reactor), before the other is in need of regeneration. In this case regeneration conditions may be continued, the reactor may be sealed off or the flow rate and/or the temperature in the regeneration reactor may be reduced to save cost.

In one aspect, the in-situ catalyst regeneration step comprises washing the fixed bed reactor with water or an aqueous solution. Here the reactor is washed with water either by continual addition of wash water or by filling the reactor with water and subsequently emptying its contents after suitable residence time. The salt is released due to the solubility of the ionic compound in the aqueous solution.

### Process Operation

In one aspect, the process for hydrotreating a liquid oil stream of the present invention is a continuous operation.

The term continuous operation, as is well known in the art, means that the incoming stream of liquid oil during a given production cycle is constant, as also is the stabilized liquid oil stream being withdrawn as the outcoming product.

In one aspect, the process for hydrotreating a liquid oil stream of the present invention is a continuous operation. In one aspect of the process discussed herein, during the catalyst regeneration step, the liquid oil stream is subjected to a hydrotreatment step in a second fixed bed reactor comprising hydrotreating the liquid oil stream in the second fixed bed reactor, wherein the second fixed bed reactor comprises a hydrotreatment catalyst. In this case, the process for hydrotreating a liquid oil stream can remain online in the second fixed bed reactor whilst the hydrotreatment catalyst of the first fixed bed reactor is regenerated in accordance with the above aspects.

In one aspect, the process of the present invention further comprises a second catalyst regeneration step such that one or more ammonium salts deposited on the hydrotreatment catalyst of the second fixed bed reactor are removed from the second fixed bed reactor hydrotreatment catalyst.

In one aspect, during the second catalyst regeneration step such that one or more ammonium salts deposited on the hydrotreatment catalyst of the second fixed bed reactor are removed from the second fixed bed reactor hydrotreatment catalyst, the liquid oil stream undergoes a hydrotreatment step comprising hydrotreating the liquid oil stream in the first fixed bed reactor at a temperature of less than 250° C., wherein the fixed bed reactor comprises a hydrotreatment catalyst.

In other words, hydrotreatment of the liquid oil stream may continue in the second fixed bed reactor whilst the hydrotreatment catalyst in the first fixed bed reactor is being regenerated and hydrotreatment of the liquid oil stream may continue in the first bed reactor whilst the hydrotreatment catalyst in the second fixed bed reactor is being regenerated.

The process of the present invention may comprise one or more further steps. These one or more further steps may be before, after, or intermediate to the steps recited herein.

For example, the effluents from the on-stream reactor and the regenerated reactor are mixed with other streams such as recycle oil streams and additional treat gas streams. The mixture is heated and treated in subsequent reactors. The stream is kept at high temperature through the process to ensure that the salts do not precipitate until the point where the effluent is washed with water. After washing the salts are moved to water phase and the sour water is sent to further treating.

In one aspect, the process involves further steps subsequent to the in-situ catalyst regeneration step that relate to treatment of the ammonium salts released from the hydrotreatment catalyst of the fixed bed reactor. For example, given that the in-situ catalyst regeneration step involves heating the hydrotreatment catalyst with a flushing gas, or mixtures of a flushing gas and hot product oil, the released gases comprising components of the ammonium salts (e.g., NH₃ and HCl) are sent to the effluent for washing at the wash water injection point.

In one aspect, the process relating to the treatment of the ammonium salts released from the hydrotreatment catalyst is dependent on the quantity of salt to be removed and the time period for removal and catalyst regeneration as well as the capacity of downstream equipment. With such information, the following parameters can be selected:
The gas flow used in stripping operation. Higher gas flow implies higher regeneration rate;
The temperature of stripping. The higher temperature the higher concentration of NH₃ and HCl in the gas is achievable; and
Operating pressures. Low pressure flow implies higher gas concentration of NH₃ and HCl and thus a higher regeneration rate,

Assuming a constant operating pressure, the gas flow and temperature together will give a regeneration rate, when other factors are considered (efficiency due to mass transport limitation, found by experiment, time fraction available for real stripping, time needed to recondition the reactor before and after stripping). By varying the gas flow and temperature, the suitable stripping operating condition can be identified that fulfils the catalyst bed stripping in the available time frame. In one aspect, the process has a three-phase separation step; splitting, gas and non-polar (hydrocarbon) and polar (aqueous) phases.

In one aspect the regeneration rate is controlled by variation of temperature, pressure and flushing gas flow rate, such that the rate of released sublimation products from a reactor in regeneration mode, e.g. NH₃ and HCl is at least 50% and less than 150% or 200% of the amounts directed to the three-phase separation step from a stabilization reactor in operation mode. As feedstock fluctuates and regeneration typically would start at an elevated rate, these values may be calculated and compared instantaneously (i.e. on an hourly basis or faster) or on an averaged basis, such as daily, weekly, monthly or half-year basis.

In one aspect, the catalyst regeneration step may be carried out at elevated pressure, such as 90% to 110% of the pressure of the hydrotreatment step with gases directed to the existing washing and separation equipment, so extra equipment is not required.

In one aspect, the catalyst regeneration step may be carried out at a pressure substantially corresponding to atmospheric pressure, with gases directed to dedicated catalyst regeneration washing and separation equipment, allowing for increased efficiency of removal, due to increased gas concentrations of e.g. NH₃ and HCl.

In one aspect, the process further comprises passing the stabilized oil stream through a hydrotreatment step in which heteroatoms are removed by hydrotreatment (HDT), specifically hydrodemetalation (HDM), hydrodenitrogenation (HDN), hydrodeoxygenation (HDO) and hydrodehalogenation (HDH) steps using a single or multiple catalysts with properties well known to the skilled person familiar with the impurities. Thereby, any organic nitrogen present in the stabilized pyrolysis oil stream is removed and a hydrotreated stream is produced, which can be further treated for producing hydrocarbon products suitable as petrochemical feedstock as well as hydrocarbon products boiling in the transportation fuel range, such as diesel, jet fuel and naphtha. The further treatment may include any of: hydrodewaxing, hydrocracking, or isomerization, as is well known in the art of fossil oil refining. Other types of hydrotreating are also envisaged, for instance hydrodearomatization (HDA). The material catalytically active in hydrodearomatization typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof).

### Benefits of the Invention

A first embodiment relates to a process for regeneration of a process enclosure in which precipitation of ammonium salts has occurred on a catalyst, comprising the steps of directing a flow of a flushing stream comprising a flushing gas at a pressure from 0.5 MPag to 25 MPag, at a regeneration temperature above the sublimation temperature and below the activation temperature for stripping deposited carbon and hydrocarbons, to provide a flow of enriched gas and after the regeneration a process enclosure comprising a reduced amount of ammonium salts, wherein precipitation of ammonium salts has occurred on the catalyst to an extent such that a continuous volume of at least 1 liter of catalyst is found inside the process enclosure which contains at least 10 wt % ammonium salts.

This has the associated benefit of providing a process under conditions similar to operations, which efficiently re-activates a process enclosure, commonly a reactor containing catalyst, but possibly a heat exchanger or other process equipment in which fouling is critical. The activation may deliberately be made at a moderate gas flow, to avoid excessive release of ammonium salts, which may cause challenges elsewhere in the process. In addition to the gas flow a flow of already treated oil in the process may be preferred, but it is preferably avoided to have an oil releasing significant amounts of ammonium salt precursors, such that a net decrease is observed in the ammonium salts in the process enclosure. The regeneration is in this embodiment limited to situations where a substantial precipitation has occurred, such as a non-negligible volume of 1 liter has been contaminated by an amount of ammonium salts which has a negative impact on catalytic activity. The criterion for starting regeneration may alternatively be selected to involve a larger amount of catalyst being affected, such as 10 liter or 100 liter, which would allow for a temporary solution of the problem by increasing the volume of catalyst. The limit for the amount of catalyst affected may also be defined as when the relative horizontal area of a catalyst bed in which at least 10 cm of catalyst has an ammonium salt concentration is above 60%, since the common precipitation would be in an zone with similar temperature, which would be the majority of such a substantially horizontal area. The limit for the content of ammonium salts may also be higher, such as 15 wt % or 30 wt % in combination with either of the volume definitions, allowing for a longer operation before regeneration, at the cost of moderate decrease in process performance. Alternative measures of substantial precipitation may be based on an increase in pressure drop being above 20 kPa or 50 kPa or catalyst activity being reduced by more than 5%, 10% or 20% compared to the activity of a fresh catalyst or freshly regenerated catalyst, as calculated from the conversion of organically bound halides. The similar regeneration may also be carried out for process equipment in which blockages have occurred, and in that case the criteria for initiating regeneration may be made upon process disturbances such as flow irregularities or pressure drops.

A second embodiment, relates to an aspect of the first embodiment in which the process of regeneration is carried out for a period of at least 100 hours, 200 hours or 400 hours.

This has the associated benefit of providing a process for flushing ammonium salts from the catalyst in such a contaminated process enclosure. The reactor may contain, even a higher volume, such as 10 l, 100 l or 1 m³ of catalyst comprising at least 10 wt %, 20 wt % or 40 wt % ammonium salts

A third embodiment relates to an aspect of the first or second embodiment, wherein said regeneration temperature is above 150° C., 160° C., 200° C., 220° C. or 250° C.

This has the associated benefit of providing an elevated temperature enabling the gas flow to be the limiting factor for regeneration rate, thus allowing simple control of the ammonium salt released to the gas phase. Alternatively, the lower limit may be defined as the temperature where the regeneration conditions, i.e. pressure and gas flow rate of pure hydrogen and absent oil at the start of regeneration results in a contribution of hydrogen halides in the outlet stream from regeneration at least 1 ppmᵥₒₗ as measured directly in the gas phase or indirectly in the water phase of washing water, as established by pilot scale test designed to appropriate scale or as established by theromodynamical calculations. A higher temperature would result in a higher regeneration rate and therefore the regeneration temperature may also be determined as the temperature where the outlet stream contains 10 ppmᵥₒₗ or 100 ppmᵥₒₗ hydrogen halides.

A fourth embodiment relates to an aspect of any of the previous embodiments, wherein said regeneration temperature is below 320° C., 300° C. or 290° C.

This has the associated benefit of providing conditions at which hydrogen stripping by consumption of hydrogen and formation of methane is avoided, by being below the temperature of activation for these processes. Alternatively, the upper limit may be defined as the temperature where the regeneration pressure and flow rate results in a contribution of hydrocarbons in the outlet stream of less than 10 ppmᵥₒₗ or where the consumption of hydrogen is less than 10 ppmᵥₒₗ of the inlet hydrogen, by means similar to those for determining the lower temperature limits.

A fifth embodiment relates to an aspect of any of the previous embodiments, wherein said regeneration temperature is maintained below 190° C. or 210° C., for an initial period of mild regeneration, such as at least 5 hr, 20 hr, 100 hr or 500 hr, before increasing the regeneration temperature.

This has the associated benefit of avoiding or minimizing effects of volume expansion of ammonium chloride transitioning from a solid phase to another solid phase, until an amount of ammonium chloride has been released, thus avoiding structural damage to the catalyst.

A sixth embodiment relates to an aspect of any of the previous embodiments, wherein a control system is configured to control the one or more of the flow of the flushing stream and the regeneration temperature in dependence of a rate of release of ammonium salts, to keep the concentration in the enriched gas below a defined limit.

This has the associated benefit of avoiding release problematic amounts of corrosive hydrogen halides or other compounds being challenging in the process, and furthermore providing the potential for dynamically adjusting the conditions when the rate of release is reduced as regeneration progresses.

A seventh embodiment relates to an aspect of any of the previous embodiments, wherein the enriched gas, optionally after combination with other gases is directed to contact an aqueous liquid, for transferring water soluble compounds to the aqueous liquid.

This has the associated benefit of withdrawing the ammonium salts from the gas phase, and directing them to water treatment.

An eighth embodiment relates to an aspect of the sixth or seventh embodiment, wherein the regeneration rate is monitored by one or more of the following, analysis of gas composition of the flushing gas and the enriched gas or analysis of the composition of the aqueous liquid.

This has the associated benefit of providing data enabling an effective operation balancing rapid regeneration and minimal risk of challenges associated with released ammonium salts.

A ninth embodiment relates to an aspect of any of the previous embodiments, wherein the flushing gas comprises at least 70 vol % hydrogen and optionally at least 10 ppmᵥₒₗ such as 50 ppmᵥₒₗ sulfide.

This has the associated benefit of providing a gas which keeps the catalyst activated, either in reduced form in absence of sulfide or in active sulfided form with presence of sulfide. The sulfide may be provided from the processes, or it may be added as hydrogen sulfide, dimethyl-disulfide or in other forms.

A tenth embodiment relates to a process for hydrotreating a liquid oil stream comprising a reactive feedstock involving at least two reactors; wherein the liquid oil stream comprises at least 1 ppm wt halides, 20 ppm wt halides, 50 ppm wt halides or 100 ppm wt halides in combination and at least 1 ppm wt N, 10 ppm wt N, 50 ppm wt N, 100 ppm wt N or 500 ppm wt N; the process comprising:
(i) directing said stream comprising a reactive feedstock and a first hydrogen rich gas to a stabilization hydrotreatment step comprising hydrotreating the liquid oil stream, having a liquid oil flow rate, in a fixed bed reactor at a stabilization temperature of less than 250° C., wherein the fixed bed reactor comprises a hydrotreatment catalyst and said step providing a hydrotreated multiphase stream; and
(ii) in an in-situ catalyst regeneration step comprising flushing the hydrotreatment catalyst at a regeneration temperature at or above said stabilization temperature and below a maximum regeneration temperature with a flushing gas having a flushing gas flow rate, providing an enriched gas, wherein the ratio of flushing gas flow rate to liquid oil flow rate is at least 0.5 Nm³/m³ such as 10 Nm³/m³ or 100 Nm³/m³ and less than 500 Nm³/m³, 1000 Nm³/m³, or 5000 Nm³/m³.

This has the associated benefit of providing a continuous process for low temperatures stabilization of a stream comprising a reactive feedstock, originating from thermochemical decomposition and containing precursors for ammonium salts, by providing efficient in-situ regeneration of the catalyst. In specific embodiments the content of reactive feedstock in the stream may be at least 25 wt %, 50 wt % and up to 100 wt %. The stabilization temperature may considered as the inlet temperature, but a regeneration temperature above the outlet temperature may also be selected, as the precipitation is likely to occur at the bottom of the reactor, where temperature and thus reactivity is highest.

An eleventh embodiment relates to an aspect of the tenth embodiment wherein said hydrotreatment step (i) is carried out in a first reactor and said in-situ catalyst regeneration step (ii) is carried out in a second reactor, and the hydrotreated two-phase stream is optionally in combination with said enriched gas separated in an off-gas gas stream and a liquid hydrotreated product, and said off-gas gas stream and said enriched gas, optionally together with other streams, are directed to be combined with an aqueous stream to provide a contaminated aqueous stream and a purified off-gas, and wherein the process configuration may be reconfigured such that step (i) is carried out in the second reactor and step (ii) is carried out in the first reactor.

This has the associated benefit of providing a process without significant downtime, even after precipitation of ammonium salts.

A twelfth embodiment relates to an aspect of the eleventh embodiment, wherein at least an amount of the off-gas stream is comprised in said flushing gas.

This has the associated benefit of simplifying the gas handling and gas cleaning and reducing hydrogen consumption in such a process.

A thirteenth embodiment relates to an aspect of the twelfth embodiment, wherein said contaminated aqueous stream contains less than 5000 ppm_{wt} halides, 2000 ppm_{wt} halides or 1000 ppm_{wt} halides.

This has the associated benefit of providing conditions with reduced corrosion risk, such that potentially carbon steel or low grade corrosion resistant steel may be used. Furthermore, the limit will also result minimum amounts of halides in the recycle gas.

A fourteenth embodiment relates to an aspect of the tenth, eleventh, twelfth or thirteenth embodiment, wherein an amount of said purified off-gas is comprised in said hydrogen rich gas.

This has the associated benefit of recycling the unconsumed hydrogen, and thus reducing the cost of operation.

A fifteenth embodiment relates to a process plant comprising two reactors, and means of flow control, configured for enabling a process according to claim 10 and claims dependent thereon.

### BRIEF DESCRIPTION OF THE DRAWINGS

Embodiments of the present invention are explained by way of examples and with reference to the accompanying drawings. The appended drawings illustrate only examples of embodiments of the present invention, and they are therefore not to be considered limiting of its scope, as the invention may admit to other alternative embodiments.

FIG. 1. shows a process layout according to the present invention.

FIG. 2. shows the reactor loading scheme employed in Example 1.

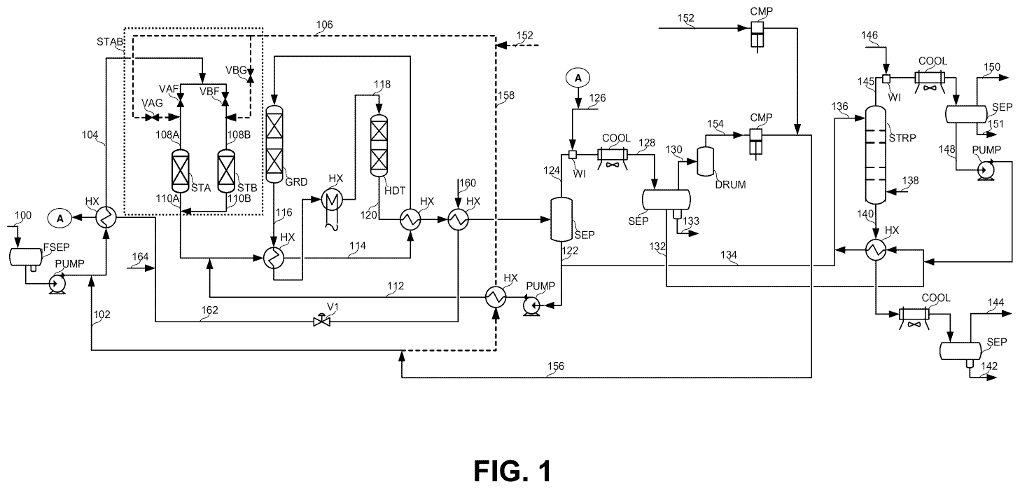

FIG. 1 shows a process layout according to the present disclosure. In this Figure, heat exchangers (HX), coolers (COOL), pumps (PUMP), compressors (CMP) and separators (SEP) are designated by their label but only singled out when relevant. In FIG. 1 which water is separated from a reactive feedstock (100) in a feed separator and heated before being combined with an amount of hydrogen rich gas (102) and directed as feed stream (104) to a stabilization section (STAB) comprising a first stabilizer (STA), with related valves (VAF, VAG) and a similar second stabilizer (STB) and valves (VBF, VBG). The stabilization section is configured for having one stabilizer operating in a stabilization hydrotreatment mode while the other may operate in a regeneration mode. When the first stabilizer (STA) operates in stabilization hydrotreatment mode, feed valve A (VAF) is open, while gas valve A (VAG) is closed. At the same time, the second stabilizer (STB) operates in regeneration mode, with feed valve B (VBF) closed and gas valve B (VBG) open. Thereby the feed stream (104) is directed to stabilizer A in a first inlet line (108A), while a flushing gas stream (106) is directed to stabilizer B in a second inlet line (108B). The outlet stream (110A) from the first stabilization reactor (STA) is a two-phase stream comprising stabilized liquid and gases. The outlet stream (110B) from the second stabilization reactor (STB) may be a gas stream comprising the flushing gas and flushed ammonium halides, or alternatively a two-phase stream, if the system was configured for the flushing stream to comprise liquid, which may be beneficial for the stability of the catalyst. The two outlet streams and an amount of recycled product stream (112) are combined to a single stream (114) which is heated by process heat and directed to a guard reactor (GRD) in which metals and other heteroatoms forming solids compounds are removed, forming a purified hydrocarbon stream (116) which is directed to a hydrotreatment reactor (HDT) to provide a two-phase hydrocarbon rich stream (120).

The two-phase hydrocarbon rich stream (120) is separated into a gas phase product stream (124) and a first liquid product stream (122) of which an amount may be directed as recycled product stream (112). The gas phase product stream (124) is combined with an amount of wash water (126) in a water injector. This stream is cooled, such that the effluent stream may be separated in three phases, light product (132), sour water (133) and hydrogen rich gas (130) from which liquid is removed in a knock-out drum (DRUM). An amount of the first liquid product stream (134) and the light product (132) are combined and directed as a stripper feed (136) to a product stripper (STRP), which receives a stripping medium (138), commonly hydrogen. Water (142) is withdrawn from the stripped product (144). The stripper overhead (145) is washed with water, cooled and separated in sour water (151) and reflux (148).

The process gas loop as illustrated, involves directing make up hydrogen gas (152) to be combined with the hydrogen rich washed gas (154) and directed as recycle gas (156) which is split in the flushing gas (158) and the hydrogen rich recycle gas (102). To maintain catalyst activity, a sulfiding stream (152) is added to the flushing, unless the feedstock or recycle gas contains sufficient amounts of sulfur for maintaining sulfidation. This may be dimethyl disulfide or another sulfide containing stream.

The temperature of the warm flushing gas (158) controls the rate of sublimation in the stabilization reactor being regenerated. The temperature of this stream and the stream to stabilization hydrotreatment (104) is in this embodiment controlled by the heat integration considering temperatures and flows of the recycle gas (156), hot liquid recycle (112), hydrogen rich gas (102), feedstock (100) in connection with a steam circuit controlled by valve (V1) and involving boiler feed water (160), steam (162) and added hot high pressure steam (164), but other heat integration schemes may also be designed.

### EXAMPLES

The invention will now be described with reference to the following non-limiting examples.

The following example illustrates the ability of thermal stripping of ammonium salts, by a simulation of rapid regeneration of catalysts containing a moderate amount of ammonium chloride.

The precipitation and sublimation of ammonium salts is described by the following reversible reaction (only the reaction for NH₄Cl is shown)

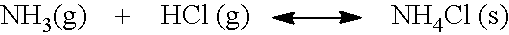

The equilibrium is governed by a equilibrium constant Kp, defined as:

$$K p = {P}_{{NH}_{3}} * {P}_{HCl}$$

where P_{NH}_{₃} is the partial pressure of NH3 and P_{HCl} is the partial pressure of HCl. Kp is dependent on temperature. The relation between Kp and temperature can be found in API Recommended Practice 932-B, Third Edition, June 2019. Kp is large at high temperature. Kp defines a maximum product of P_{NH3} With P_{HCl} (P_{NH3}*P_{HCl}) in the gas phase at a given temperature. If the product of partial pressures of NH₃ and HCl is at maximum, we consider the gas saturated.

The regeneration rates of solid ammonium chloride from a catalyst via sublimation were tested using NH₄Cl-loaded 1/20″ trilobe alumina-based catalyst support extrudates (surface area: 240 m²/g, pore volume: 1.0 ml/g). The NH₄Cl-loaded extrudates were prepared with NH₄Cl loadings of ca. 9 wt % and a NH4+:Cl⁻ molar ratio of 1.04-1.11 as measured by ion chromatography for NH₄⁺ (ASTM D6919) and Cl⁻ (ASTM D4327)

Baseline experiments accounting for effects of the loading and unloading procedure of the NH₄Cl-loaded extrudates in and out of the reactor, and any fast initial phenomena, were carried out under experimental conditions where ≤2.5% of the initial NH₄Cl could be removed on the basis of a NH₃₋ and HCl-saturated reactor exit gas from NH₄Cl(s) decomposition. The baseline experiments were carried out in H₂, and in H₂+oil (hydrodesulfurized heavy naphtha, petroleum, white spirit type 1), at temperatures of 200° C. and 5 MPag for a duration of 3 hrs, 250° C. and 5 MPag for a duration of 2 hrs, and 300° C. and 16 MPag for a duration of 0.5 hrs. This resulted in NH4⁺ mass balances (after/before) of 0.79 (within 4%) and Cl⁻ mass balance of 0.95 (within 5%), and resulting NH₄⁺:Cl⁻ molar ratios of 0.93 (within 6%). The fast initial step of some NH₃-loss from the NH₄Cl-loaded extrudates is assigned to a combination of desorption of superfluous NH₃ from the sample preparation (NH₄⁺:Cl⁻ molar ratio of 1.04-1.11) and a fast partial NH₄Cl decomposition step to form chlorine chemical bonds with the alumina surfaces and a resulting NH₃ desorption at 200-300° C. The latter is well-known and is evident in Example 1 on the basis of the NH₄⁺:Cl⁻ molar ratios (<<1) after that test.

These experiments were carried out with a gas flow of 42.4 Nl/hr over 3 beds of catalyst support comprising NH₄Cl having a total volume of 120 ml, resulting in a GHSV of 353 Nm³m⁻³hr⁻¹ for all three beds to be regenerated.

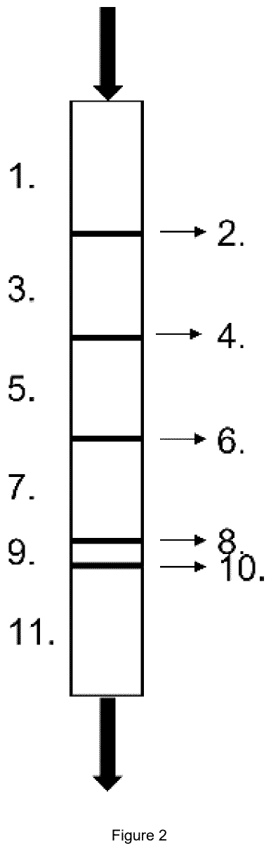

Experiments designed to remove significant amounts of NH₄Cl in a matter of a few days were also carried out, and the results are provided below. For this example, the reactor loading scheme is shown in FIG. 2 was employed, wherein the reference numerals for the reactor layers are as follows.
1. 3 mm acid-washed glass beads
2. Glass wool wad
3. NH₄Cl-loadedi alumina-based support
4. Glass wool wad
5. NH₄Cl-loaded alumina-based support
6. Glass wool wad
7. NH₄Cl-loaded alumina-based support
8. Glass wool wad
9. Alumina-based support
10. Glass wool wad
11. Alkali-loaded alumina

### Example 1

Flow: H₂ 42.4 Nl/hr, GHSV 353 Nm³m⁻³hr⁻¹, Pressure: 5 MPag, Temperature: 250° C., Duration: 30 hrs

| | | | | | Final |
|---|---|---|---|---|---|
| | Initial | Initial | Final | Final | NH4/Cl |
| Layer | NH4+/g | Cl−/g | NH4+/g | Cl−/g | molar ratio |
| 3 | 0.55 | 1.04 | 0.10 | 0.50 | 0.37 |
| 5 | 0.55 | 1.04 | 0.15 | 0.60 | 0.42 |
| 7 | 0.55 | 1.04 | 0.21 | 0.73 | 0.45 |
| 9 | 0.00 | 0.00 | 0.08 | 0.33 | 0.39 |
| 11 | 0.00 | 0.00 | 0.07 | 0.42 | 0.09 |
| 2 + 4 + 6 | 0.00 | 0.00 | 0.00 | 0.05 | 0.02 |
| 8 + 10 | 0.00 | 0.00 | 0.03 | 0.18 | 0.32 |
| Reactor exit | 0.00 | 0.00 | 0.07 | 0.15 | 0.96 |
| Mass balance | | | 0.44 | 0.95 | |

As can be seen, salt removal from the reactor bed was observed upon treatment with the hydrogen gas stream at the temperatures, pressures and times used.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, chemical engineering or related fields are intended to be within the scope of the following claims.

We claim:

1. A process for regeneration of a process enclosure in which precipitation of ammonium salts has occurred on a catalyst, comprising the steps of directing a flow of a flushing stream comprising a flushing gas at a pressure from 0.5 MPag to 25 MPag, at a regeneration temperature above a sublimation temperature and below an activation temperature for stripping deposited carbon and hydrocarbons, to provide a flow of enriched gas and after the regeneration, the process enclosure comprising a reduced amount of ammonium salts, wherein precipitation of ammonium salts has occurred on the catalyst to an extent such that a continuous volume of at least 1 liter of catalyst is found inside the process enclosure which contains at least 10 wt % ammonium salts.

2. A process according to claim 1 in which the process of regeneration is carried out for a period of at least 100 hours.

3. A process according to claim 1, wherein said regeneration temperature is above 150° C.

4. A process according to claim 1, wherein said regeneration temperature is below 320° C.

5. A process according to claim 1, wherein said regeneration temperature is maintained below 210° C., for an initial period of mild regeneration before increasing the regeneration temperature.

6. A process according to claim 1, wherein a control system is configured to control one or more of the flow of the flushing stream and the regeneration temperature in dependence of a rate of release of ammonium salts, to keep the concentration in the enriched gas below a defined limit.

7. A process according to claim 1, wherein the enriched gas, optionally after combination with other gases is directed to contact an aqueous liquid, for transferring water soluble compounds to the aqueous liquid.

8. A process according to claim 6, wherein the regeneration rate is monitored by one or more of the following, analysis of gas composition of the flushing gas and the enriched gas or analysis of the composition of the aqueous liquid.

9. A process according to claim 1, wherein the flushing gas comprises at least 70 vol % hydrogen and optionally at least 10 ppmᵥₒₗ such as 50 ppmᵥₒₗ sulfide.

10. A process for hydrotreating a liquid oil stream comprising a reactive feedstock involving at least two reactors; wherein the liquid oil stream comprises at least 1 ppm wt halides in combination and at least 1 ppm wt N; the process comprising:
(i) directing said stream comprising a reactive feedstock and a first hydrogen rich gas to a stabilization hydrotreatment step comprising hydrotreating the liquid oil stream, having a liquid oil flow rate, in a fixed bed reactor at a stabilization temperature of less than 250° C., wherein the fixed bed reactor comprises a hydrotreatment catalyst and said step providing a hydrotreated multiphase stream; and
(ii) in an in-situ catalyst regeneration step comprising flushing the hydrotreatment catalyst at a regeneration temperature at or above said stabilization temperature and below a maximum regeneration temperature with a flushing gas having a flushing gas flow rate, providing an enriched gas,
wherein the ratio of flushing gas flow rate to liquid oil flow rate is at least 0.5 Nm³/m³ and less than 5000 Nm³/m³.

11. A process according to claim 10 wherein said hydrotreatment step (i) is carried out in a first reactor and said in-situ catalyst regeneration step (ii) is carried out in a second reactor, and
the hydrotreated two-phase stream is optionally in combination with said enriched gas separated in an off-gas gas stream and a liquid hydrotreated product,
and said off-gas gas stream and said enriched gas are directed to be combined with an aqueous stream to provide a contaminated aqueous stream and a purified off-gas,
and wherein the process configuration may be reconfigured such that step (i) is carried out in the second reactor and step (ii) is carried out in the first reactor.

12. A process according to claim 11, wherein at least an amount of the off-gas stream is comprised in said flushing gas.

13. A process according to claim 12, wherein said contaminated aqueous stream contains less than 5000 ppm_{wt} halides.

14. A process according to claim 10, wherein an amount of said purified off-gas is comprised in said hydrogen rich gas.

15. A process plant comprising two reactors, and means of flow control, configured for enabling a process according to claim 10.

16. A process according to claim 5, wherein said initial period of mild regeneration has a duration of at least 5 hr.
